(19) United States
(12) Patent Application Publication
(10) Pub. No.: US 2026/0030374 A1
(43) Pub. Date: Jan. 29, 2026

(54) SYSTEM AND METHOD FOR GENERATION AND INTEGRATION OF CUSTOM OBJECTS INTO ARCHITECTURE DIAGRAMS

(71) Applicant: T-Mobile USA, Inc., Bellevue, WA (US)

(72) Inventor: Sreedhar R. Busanelli, Overland Park, KS (US)

(21) Appl. No.: 18/781,143

(22) Filed: Jul. 23, 2024

(51) Int. Cl. G06F 21/62

(52) U.S. Cl. CPC G06F 21/6218

(57) ABSTRACT

A system to receive diagrams associated with an organization. The system may be configured to convert the diagrams into diagram data or code that may be stored at a location designated by the organization to allow other users of the organization to access the diagram. In some cases, the system may be configured to provide the diagram data to the other users of the organization in a format requested by each of the other users.

### BACKGROUND

Typically, within an organization, architecture diagrams are developed per team or group using a wide variety of different software tools. In some cases, the tools used to develop a particular diagram may become unlicensed or be sunset by the organization resulting in the particular diagram being inaccessible by the current staff of the organization. In other cases, the particular tool being used by a team may be unsecure or fail to meet organization polices, such as cyber security policies, privacy policies, or the like.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is an example block diagram of a system and platform for managing and storing diagrams associated with an organization, according to some implementations.

FIG. 2 is a flow diagram illustrating an example process associated with storing a diagram, according to some implementations.

FIG. 3 is a flow diagram illustrating an example process associated with a system granting access to diagrams in a requested format, according to some implementations.

FIG. 4 is an example system that may implement the techniques described herein according to some implementations.

### DETAILED DESCRIPTION

Discussed herein are systems and devices for providing uniform diagrams, such as architecture diagrams, across an organization employing multiple development teams. In some cases, the system may be configured to allow a user to prepare a diagram using a preferred local tool or software system (including or cloud-based tools). Each of the local tools may include a set of custom objects (e.g., icons, lines, connectors, and the like). In some cases, each of the custom objects may include meta data proving specific relationships, operations, and the like.

In various implementations, when a user is ready to save or otherwise store the prepared diagram, the user may upload or cause the system, discussed herein, to process the diagram for storage at one or more datastores owned and/or maintained by the organization. In this manner, the system may receive a copy of the diagram in a format supported by the local tool. The system may then convert the diagram in the format supported by the local tool to one or more other formats preferred by the organization. For example, the system may convert each object from the format supported by the local tool to a format preferred by the organization. In this manner, the system may maintain the metadata associated with each object including object relationships, object connotations, object significance, associated operations, and the like.

In some examples, the system may utilize one or more machine learning models that receive as an input the diagram in the format supported by the local tool and to output a diagram in one or more additional formats, such as the formats preferred by the organization. For example, the one or more machine learning models may be trained on diagram data from various tools, including local tools, customized tools built by various groups within the organization, cloud-based tools, and the like.

In some cases, the training data may include diagrams in a fixed format (such as a PDF) while in other cases, the training data may include diagrams having various types of metadata (such as object relationships, object connotations, object significance, associated operations, and the like). In some cases, the training data may include standalone objects, such as icons used to represent specific types of operations or actors within a diagram. In some cases, the training data may be various types of architectural diagrams, such as network architecture diagrams, system architecture diagrams, taxonomy diagrams, flow charts, process architecture diagrams, development architecture diagrams, deployment architecture diagrams, concept architecture diagrams, and the like.

As one specific example, the one or more machine learning models may include a first machine learning model to segment the diagram into objects. For example, the first machine learning model may segment the diagram's icons into individualized objects. In some cases, the first machine learning models may be trained on diagram data and icon data from various tools and in various formats. A second machine learning model may be configured to classify the segmented data (e.g., the objects). For example, the second machine learning model may assign a type or class to each of the objects, such as network node, server, endpoint device, and the like.

In some specific examples, the second machine learning models may be trained based on object data associated with diagrams and various corresponding roles, associated operations, and the like. The one or more machine learning models may include a third machine learning model to determine relationships (e.g., connections, associations, joint operations, flows, and the like) between the segmented and classified objects. The third machine learning model may be trained on pairs of object data, diagram data (e.g., having connections or flow paths), and the like. In some cases, another machine learning model or the third machine learning model may also be trained to generate metadata for each object and/or pairs of objects.

In some examples, the system may include a fourth machine learning model to reconstruct the diagram in the preferred format of the organization. For example, the fourth machine learning model may receive the segmented and classified object data as well as any relationship data. The fourth machine learning model may then generate and output a corresponding diagram in the preferred format of the organization which may then be stored and accessed by other users of the system. In some cases, the system may store the segmented and classified object data and the relationship data and in response to an access request generate the diagram in the preferred format of the organization, team, or user. In this manner, the system may be flexible to accommodate changes, upgrades, or other progression in the preferred format (such as when the organization changes service providers, tools are upgraded or sunset, and the like). In some specific examples, the object data, relationship data, metadata, and the like may be stored as code usable or executable by an application to reconstruct the diagram in various formats.

For instance, in some implementations, the system may receive a request to access or output a specific diagram, such as a first diagram. In some cases, the requests may include an indication of a desired format for the first diagram or desired application for accessing the first diagram. In some situations, the format requested by the user may differ from the preferred format of the organization and the original format of the diagram. In these cases, the system may be configured to convert the stored diagram (and/or the object data and relationship data) into the format indicated in the request. For example, the system may utilize another machine learning model, such as a fifth machine learning model to receive as an input the object data, the relationship data, the metadata for each object, and/or the indication of the desired format and to output a diagram in the desired format that corresponds to the original diagram. In some cases, the fifth machine learning model may also be trained to receive the diagram in various formats in lieu of or in addition to the object data and the relationship data.

In some implementations, the system may be configured to receive text-based and/or verbal (e.g., audio based) data inputs from a user related to the diagram or in lieu of the original diagram. For example, the text-based or verbal data inputs may be provided as edits to the original diagram. In these examples, the system may receive the diagram as well as the text-based and/or verbal data inputs from the user, the object data from the datastore, or the like. The system may then input the text-based and/or verbal data inputs and the diagram or object data into a sixth machine learning model that may be trained on object data, diagrams in various formats, one or more language models (either or both text-based or audio-based in one or more languages, dialects, accents, and the like), and the like.

In some cases, the system may also be configured to receive the text-based or verbal data inputs from the user and to generate based at least in part on the inputs a diagram in one or more formats requested by the user. In this manner, the system may assist the user in generating diagrams via user inputs (e.g., text-based and verbal as well as other types of inputs such as image-based and the like). For instance, the system may utilize one or more seventh machine learning models (such as at least in part via a generative pre-trained transformer, large language model, or the like) to generate the diagrams from the user inputs as discussed herein.

In other examples, the system may be configured to generate an editable diagram or output data from one or more stored diagrams or use input diagrams. For example, the user may input a diagram into the system and request that the system output object data that may be edited by the user via one or more tools. As one illustrative example, the system may output the object data (e.g., the diagram) in a format editable via a Python-based tool, such as object data or code, as discussed herein. In these examples, the system may receive the edited Python-based object data or code from the user when the user has completed any desired edits and in response generate an updated diagram in one or more formats (such as a desired format, an original format, a requested format, or the like). In the case of generated code, one or more users may modify the code using various software development techniques or practices and in this manner, the system reduces development time for deployment of network or system software updates.

In some cases, the system may implement one or more polices are enforced that may be used to verify that the updated diagram, object data, code, and the like do not introduce logic and/or other errors in the generated diagram. For example, the system and the enforced policies may utilize one or more additional machine learning models or computational logical techniques to ensure that the resulting diagrams meet or exceed any organizational requirements, for example, for use in architectural drawings or diagrams implemented by the organization.

In some cases, the system may be aware of various organizational security and privacy (such as disclosure and non-disclosure) rules. In this manner, the system may be configured to receive with a request for a diagram, authentication data associated with the requesting user or third-party. The authentication data may include biometric data (such as facial data, fingerprint data, retina data, and the like), passwords, device data (such as authorized devices), account data (e.g., associated with the requesting user), and the like. The system may be configured to authenticate the user via the authentication data.

In some cases, the authentication may include determinations of portions of data the user is allowed to access and/or portions of data the user is restricted from accessing. For example, a user in a marketing department or team may require limited access to a network architecture diagram when compared with a software engineer or the like. In other examples, the requesting user may be a third-party to the organization, such as a vendor or contractor, that provides services associated with a particular area of expertise. In these cases, some portion of a diagram may be confidential to the organization and the third-party may be restricted from viewing or otherwise accessing.

In these examples, the system may determine from the authentication data an access level or a portion of a diagram or data that the user is authorized to access. In some cases, the portion may be determined based on a role of the user, an assignment of the user, an account of the user, a clearance level or security level of the user, and the like. As one illustrative example, the system may determine the user's access level for each portion of the diagram as well as a need/reasonability to access each portion for the current task. In this manner, the system may limit the portions of a diagram provided to a user based on user authorization and a current task. For example, if a user is fully authorized to view all data of the organization but the current task has a limited data requirement, the system may provide the limited portion of the diagram to the user event though they have full authorization.

In some examples, the system may also determine, such as based on a security level of the data represented in a diagram, an encryption level associated with each diagram the system generated and/or provides to a user. For example, data having a higher security level may be granted together with a higher levels of encryption.

In some cases, the original diagram format may include hand-drawn or other non-electronic tool based formats. In these cases, the system may be configured to receive image data of the diagram and to convert, such as via the one or more machine learning models, the hand-drawn diagram into the object data, relationship data, metadata, and the like that is unable to generate diagrams in various formats, such as the preferred format of the organization or a desired format of a requesting user or third-party.

In some specific implementation, the system may also be configured to generate or transform diagrams in one or more formats into configurations and/or settings for deployment to one or more network hardware devices (or other types of computational systems, software deployments, processors, devices, and the like), such as via a software update or the like. In this manner, the system may utilize the diagrams to generated executable code, settings, configuration, or the like on behalf of the user that may be implemented by a network, device, application hosted on user or network equipment, or software deployment, cloud-based service, or the like. As discussed above, in some cases, the system may utilize one or more techniques and/or machine learning models to ensure that organizational, device, hardware, software, or other policies are enforced with respect to the generated code, settings, and/or configurations such that the generated codes, settings, and configuration for deployment do not introduce errors during operational services of the network.

As described herein, the machine learning models may be generated using various machine learning techniques. For example, the models may be generated using one or more neural network(s). A neural network may be a biologically inspired algorithm or technique which passes input data through a series of connected layers to produce an output or learned inference. Each layer in a neural network can also comprise another neural network or can comprise any number of layers (whether convolutional or not). As can be understood in the context of this disclosure, a neural network can utilize machine learning, which can refer to a broad class of such techniques in which an output is generated based on learned parameters.

As an illustrative example, one or more neural network(s) may generate any number of learned inferences or heads from the captured sensor and/or image data. In some cases, the neural network may be a trained network architecture that is end-to-end. In one example, the machine learned models may include segmenting and/or classifying extracted deep convolutional features of the sensor and/or image data into semantic data. In some cases, appropriate truth outputs of the model in the form of semantic per-pixel classifications (e.g., vehicle identifier, container identifier, driver identifier, and the like).

Although discussed in the context of neural networks, any type of machine learning can be used consistent with this disclosure. For example, machine learning algorithms can include, but are not limited to, diffusion models, large language models (LLMs), regression algorithms (e.g., ordinary least squares regression (OLSR), generative pre-trained transformers (GPT), linear regression, logistic regression, stepwise regression, multivariate adaptive regression splines (MARS), locally estimated scatterplot smoothing (LOESS)), instance-based algorithms (e.g., ridge regression, least absolute shrinkage and selection operator (LASSO), elastic net, least-angle regression (LARS)), decisions tree algorithms (e.g., classification and regression tree (CART), iterative dichotomiser 3 (ID3), Chi-squared automatic interaction detection (CHAID), decision stump, conditional decision trees), Bayesian algorithms (e.g., naïve Bayes, Gaussian naïve Bayes, multinomial naïve Bayes, average one-dependence estimators (AODE), Bayesian belief network (BNN), Bayesian networks), clustering algorithms (e.g., k-means, k-medians, expectation maximization (EM), hierarchical clustering), association rule learning algorithms (e.g., perceptron, back-propagation, hopfield network, Radial Basis Function Network (RBFN)), deep learning algorithms (e.g., Deep Boltzmann Machine (DBM), Deep Belief Networks (DBN), Convolutional Neural Network (CNN), Stacked Auto-Encoders), Dimensionality Reduction Algorithms (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Algorithms (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc. Additional examples of architectures include neural networks such as ResNet50, ResNet101, VGG, DenseNet, PointNet, and the like. In some cases, the system may also apply Gaussian blurs, Bayes Functions, color analyzing or processing techniques and/or a combination thereof.

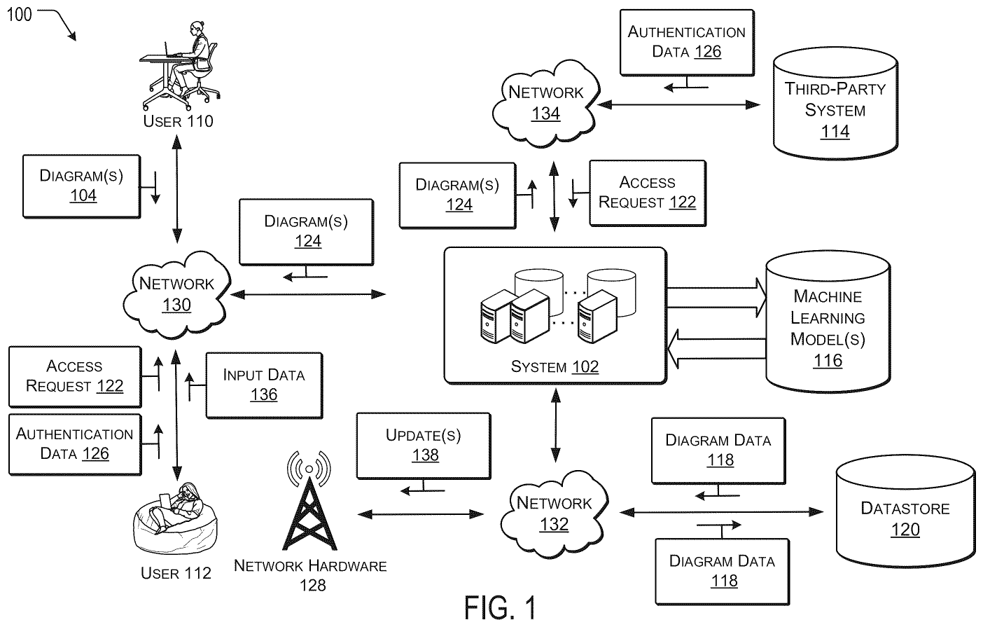

FIG. 1 is an example block diagram 100 of a system 102 for managing and storing diagrams 104 associated with an organization, according to some implementations. In the current example, the system 102 may be configured to manage a diagram datastore 106 that maintains diagram data 108 accessible by various members or users, such as users 110 and 112, as well as third-party systems 114. For example, a user 110 may generate a diagram 104 associated with an organization. The diagram 104 may be in a first format that is selected by the user 110. Once the user 110 completes or is ready to save the diagram 104, the user 110 may cause the diagram 104 to be uploaded or otherwise provided to the system 102.

The system 102 may be configured to process the diagram 104 in the current format (e.g., the format selected by the user 110) in order to convert the diagram 104 into code (such as Python code, hardware settings, hardware configuration, or the like) and/or object data. For example, the system 102 may convert each object from the first format selected by the user 110 to a second format preferred by the organization, a third format preferred by a team associated with the user 110, or the like.

In some examples, the system 102 may utilize one or more machine learning models 116 to convert the diagram 104 into diagram data 108 for storage at a datastore 106 and/or translation to another format, as discussed herein. The diagram data 108 may include object data, relationship data, metadata associated with each object, formatting data, and the like usable by the system 102 to generate copies of the diagram 104 in one or more other formats. In some cases, the diagram data 108 may be represented as code that may be used by the system 102 to generate the copies of the diagram 104 in the one or more other formats.

In some examples, the system 102 may provide or input the diagram 104 into the one or more machine learning models 116 and receive the diagram data 108 associated with the diagram 104 as an output of the one or more machine learning models 116. In some cases, the one or more machine learning models 116 may be trained on diagrams and diagram data from various tools, including local tools, customized tools built by various groups within the organization, cloud-based tools, and the like.

The training data may include diagrams in a fixed format (such as a PDF) while in other cases, the training data may include diagrams having various types of metadata (such as object relationships, object connotations, object significance, associated operations, and the like). In some cases, the training data may include standalone objects, such as icons used to represent specific types of operations or actors within a diagram. In some cases, the training data may be various types of architectural diagrams, such as network architecture diagrams, system architecture diagrams, taxonomy diagrams, flow charts, process architecture diagrams, development architecture diagrams, deployment architecture diagrams, concept architecture diagrams, and the like.

In the current example, the one or more machine learning models 116 may include a first machine learning model to segment the diagram 104 into objects. For example, the first machine learning model may segment the icons and/or text associated with the diagram 104 into individualized objects. In some cases, the first machine learning models may be trained on diagram data, textual data descriptors of objects, and icon data from various tools and in various formats. The one or more machine learning models 116 may also include a second machine learning model configured to classify the segmented data (e.g., the objects represented by the object data). For example, the second machine learning model may assign a type or class to each of the objects, such as network node, server, endpoint device, and the like. In some specific examples, the second machine learning models may be trained based on object data associated with diagrams and various corresponding roles, associated operations, and the like.

The one or more machine learning models 116 may also include a third machine learning model to determine relationship data (e.g., connections, associations, joint operations, flows, and the like) between the segmented and classified objects. The third machine learning model may be trained on pairs of object data, diagram data (e.g., having connections or flow paths), and the like. In some cases, the one or more machine learning models 116 may include a fourth machine learning model or the third machine learning model may also be trained to generate metadata for each object and/or pairs of objects.

Once the diagram data 108 associated with the diagram 104 in the first or original format is stored, other users, such as user 112 or third-party system 114, may submit a request 122 to view or otherwise access the diagram 104. In some cases, as discussed herein, the access request 122 may include an indication of a desired or specific format, such as a second format that differs from the original format. In these cases, the system 102 may be configured to convert the stored diagram data (and/or the object data, metadata, relationship data, and the like) into the format indicated in the request 122. For example, the system 102 may utilize another machine learning model, such as a fifth machine learning model, that is configured to receive the diagram data 108 and/or the indication of the desired format as an input. The fifth machine learning model may then generate and output a diagram, such as diagram 124 in the desired format that corresponds to the original diagram in the original format. In some cases, the fifth machine learning model may also be trained to receive the diagram in various formats in lieu of or in addition to the diagram data 108.

In some cases, the system 102 may be aware of various organizational security and privacy (such as disclosure and non-disclosure) rules. In this manner, the system 102 may be configured to receive, with the request 122, authentication data 126 associated with the requesting user 112 or third-party 114. The authentication data 126 may include biometric data (such as facial data, fingerprint data, retina data, and the like), passwords, device data (such as authorized devices), account data (e.g., associated with the requesting user), and the like.

The system 102 may be configured to authenticate the user 112 or the third-party system 114 via the authentication data 126. In some cases, the authentication operations may include determinations of portions of diagram data 108 the user 112 is allowed to access and/or portions of diagram data 108 the user 112 is restricted from accessing. For examples, the requesting user may be a third-party, such as third party system 114, to the organization, such as a vendor or contractor, that provides services associated with a particular area of expertise. In these cases, some portion of a diagram data 108 may be confidential to the organization and the third-party system 114 may be restricted from viewing or otherwise accessing.

In these examples, the system 102 may determine, from the authentication data 126 and the organizational rules, an access level or a portion of a diagram 124 or diagram data 108 that the user 112 or third-party system 114 is authorized to access. In some cases, the portion may be determined based on a role of the user 112, an assignment of the user 112, an account of the user 112, a clearance level or security level of the user 112, and the like.

As one illustrative example, the system 102 may determine the access level for each portion of the diagram 124 as well as a need/reasonability to access each portion for a current task. In this manner, the system 102 may limit the portions of a diagram provided to the user 112 and/or the third-party system 114 based on user authorization data 126, the rules, and a current task. For example, if a user 112 is fully authorized to view all data of the organization but the current task has a limited data requirement, the system 102 may provide the limited portion of the diagram 126 to the user 112 event though the user 112 have full authorization. In some example, the system 102 may also determine, such as based on a security level of the diagram data 108, an encryption level associated with the diagram data 108. For example, diagram data 108 having a higher security level may be provided with a higher levels of encryption.

In some cases, when the authorized user 112 access a diagram, the user 112 may provide edits or input data 136 to the diagram in the form of text-based inputs (typed inputs), visual-based inputs (e.g., drawing edits), and/or audio-based or verbal inputs (e.g., spoken commands or inputs). The input data 136 may then be utilized by the system 102 to update or generate additional diagrams from the accessed diagram 124, stored diagram data 118 associated with the accessed diagram 124, the input data 136, and the like.

In some cases, the system 102 may input the diagram 124, stored diagram data 118, and the input data 136 into one or more machine learning models as discussed herein to receive as an output the updated diagram, updated diagram data, and/or updated diagram data. In one specific example, the input data 136 may first be processed or input into one or more language, text, or image based processing machine learning models (such as a large language mode, generative pre-trained transformer, or the like) to generate inputs for the one or more machine learning models trained to update the diagrams and diagram data.

In some specific examples, the system 102 may also utilize the diagrams 104 generated as original diagrams for storage at the datastore 120 as well as the input data 136 modifying one or more diagrams, such as at a later time, as inputs to processes, techniques, and/or machine learning models that may be configured to generate, as an output, updates 134 for deployment to, for instance, network hardware 128 or other hardware, software as a service, user equipment, or the like. In this manner, the system 102 may receive diagrams 104 as well as input data 136 (e.g., updating diagrams 124) from various users, such as users 110 and/or 112, and to generate updates 138 (such as settings, configurations, software deployments, and the like) that may be provided to hardware, such as the network hardware 128, for implementation and controlling operations (such as network operations).

In the current example, the diagrams 104 and 124 as well as various types of data, such as diagram data 108 and authentication data 126, may be transmitted to the system 102 using networks, generally indicated by 130-134. The networks 130-134 may be any type of network that facilitates compunction between one or more systems and may include one or more cellular networks, radio, WiFi networks, short-range or near-field networks, infrared signals, local area networks, wide area networks, the internet, and so forth. In the current example, each network 130-134 is shown as a separate network but it should be understood that two or more of the networks may be combined or the same.

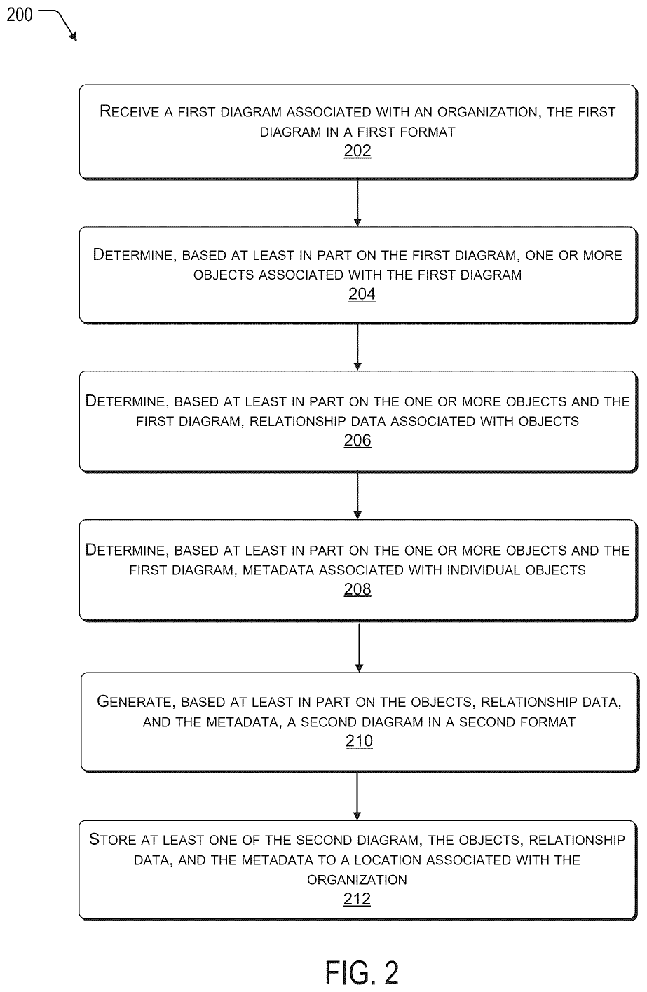

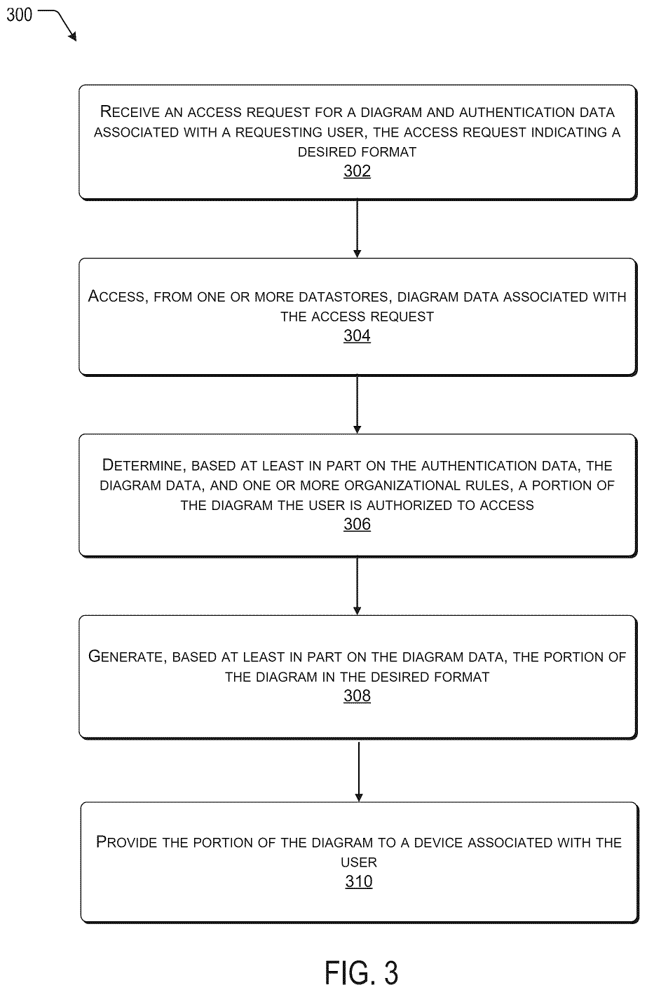

FIGS. 2 and 3 are flow diagrams illustrating example processes associated with the system discussed herein. The processes are illustrated as a collection of blocks in a logical flow diagram, which represent a sequence of operations, some or all of which can be implemented in hardware, software, or a combination thereof. In the context of software, the blocks represent computer-executable instructions stored on one or more computer-readable media that, which when executed by one or more processor(s), perform the recited operations. Generally, computer-executable instructions include routines, programs, objects, components, encryption, deciphering, compressing, recording, data structures and the like that perform particular functions or implement particular abstract data types.

The order in which the operations are described should not be construed as a limitation. Any number of the described blocks can be combined in any order and/or in parallel to implement the processes, or alternative processes, and not all of the blocks need be executed. For discussion purposes, the processes herein are described with reference to the frameworks, architectures and environments described in the examples herein, although the processes may be implemented in a wide variety of other frameworks, architectures or environments.

FIG. 2 is a flow diagram illustrating an example process 200 associated with storing a diagram, according to some implementations. As discussed above, a system may be configured to receive diagrams associated with an organization that may be prepared in a first format or a preferred format of a user or team. However, over time or in different departments, the preferred format may change and access to tools configured for the preferred format may become inaccessible and, accordingly, the diagram may be inaccessible to the user or other users associated with the organization. In this manner, the system may be configured to store the diagram as diagram data or code that may be reconfigured, recompiled, and/or reassembled in other formats usable by other tools.

At 202, the system may receive a first diagram associated with an organization. The first diagram may be in a first format selected by a user that generated the first diagram and associated with a first tool, such as a software application. In some cases, the first diagram may be a network diagram, a system diagram, an architecture diagram, a flow diagram, block diagram, as well as other types of diagrams.

In some cases, the first diagram may include icons having or representing objects or components as well as indicators of relationships or connections between icons. In some cases, the icons associated with the first diagram may be generated using one or more machine learning model (e.g., diffusion models, large language model, and the like) trained to generate icons from descriptors including text-based descriptors and verbal descriptors.

At 204, the system may determine, based at least in part on the first diagram, one or more objects associated with the first diagram. For example, the system may segment and classify the first diagram using one or more heuristics, processes, algorithms, machine learning models, or the like. For example, the system may utilize one or more machine learning models to segment the first diagram into the objects. The system may then utilize one or more second machine learning models configured to classify the segmented data (e.g., the objects represented by the object data) into types.

At 206, the system may determine, based at least in part on the one or more objects and the first diagram, relationship data associated with objects. For example, the system may determine that two objects are connected or otherwise have a relationship with each other, such as data communication, sequence of steps, or the like.

At 208, the system may determine, based at least in part on the one or more objects and the first diagram, metadata associated with individual objects. For example, the system may determine additional information associated with each icon and/or relationship within the first diagram and store the additional information as metadata associated with the induvial object, relationship, and/or pairs of objects.

At 210, the system may generate, based at least in part on the objects, relationship data, and the metadata, a second diagram in a second format. For example, the organization may have a preferred format for storing and/or accessing diagrams. In these cases, the system may be configured to convert the first diagram in the first format into the second diagram in the preferred format prior to storing. By storing the reconstructed diagram, the system may improve the overall access rate of a subsequent requesting user as the second diagram does not have to be generated from the objects, relationship data, and the metadata and the like.

At 212, the system may store at least one of the second diagram, the objects, relationship data, and the metadata to a location associated with the organization. In this manner, the system may store the second diagram or the data associated with the first diagram and unable to generated copies of the first diagram in other formats at a location that is owned and/or maintained by the organization. In this manner, the organization avoids potential loss of the first diagram when a tool is sunset, a license expires, and/or the like. In some examples, the system may store the first diagram, the second diagram, and the diagram data (e.g., the objects, relationship data, the metadata, and the like).

FIG. 3 is a flow diagram illustrating an example process 300 associated with a system granting access to diagrams in a requested format, according to some implementations. As discussed above, a system may be configured to receive diagrams associated with an organization that may be prepared in a first format or a preferred format of a user or team. However, over time or across departments, the preferred format may change and access to tools configured for the preferred format may become inaccessible and, accordingly, the diagram may be inaccessible to the user or other users associated with the organization. In this manner, the system may be configured to store the diagram as diagram data or code that may be reconfigured, recompiled, and/or reassembled in other formats usable by other tools upon receiving an access request by an authorized user.

At 302, the system may receive an access request for a diagram and authentication data associated with a requesting user, the access request indicating a desired format. For example, the access request may indicate the diagram, a task or reason for accessing the diagram, a desired format of the diagram output by the system, a tool the diagram may be accessed with, a device associated with the tool, and the like. In some cases, the access request may be by a user associated with the organization (such as an employee or the like). In other cases, the access request may be by a third-party system (such as a contractor, partner, vendor, customer, downstream or upstream supplier, or the like).

At 304, the system may access, from one or more datastores, diagram data associated with the access request. For example, the system may access the diagram data and/or a stored version of the diagram in another format that was generated in response to a completion or uploading of the requested diagram as discussed above with respect to FIG. 2. For example, the diagram data may include object data, relationship data, metadata and the like associated with the diagram.

At 306, the system may determine, based at least in part on the authentication data, the diagram data, and one or more organizational rules, a portion of the diagram the user is authorized to access. For example, a diagram may include information related to various different parts of an organization. In some cases, a supplier may only require access to a portion of the diagram that relates to the components that they supply. In this manner, the system may determine from the authentication data, that the requesting user is a supplier, that the organizational rules are to restrict the distribution of proprietary data, and that only the portion of the diagram is either authorized to be accessed by the user and/or the other portions of the diagram are not necessary information that the user needs for the completion of their task.

At 308, the system may generate, based at least in part on the diagram data, the portion of the diagram in the desired format. For example, the system may utilize one or more of a heuristics, processes, algorithms, machine learning models, or the like to generate the portion of the diagram in the desired format. For example, the system may utilize one or more machine learning models to receive as an input the diagram data and to output the diagram in the desired format. The system may then restrict or obscure any elements of the diagram other than the portion. In other cases, the one or more machine learned models may receive as an input the authentication data, organizational rules, and the task data and generated a diagram in the desired format that is limited to representing the portion.

At 310, the system may provide the portion of the diagram to a device associated with the user. In this manner, the user may access the portion of the diagram in the desired format using one or more tools installed on the device or accessible by the device (e.g., a cloud-based tool).

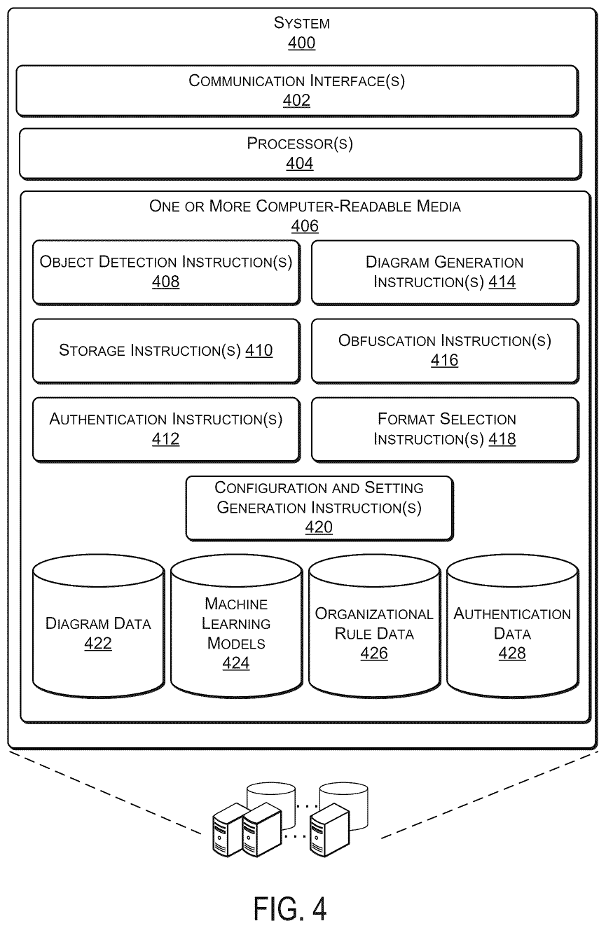

FIG. 4 is an example system 400 that may implement the techniques described herein according to some implementations. The system 400 may include one or more communication interface(s) 402 (also referred to as communication devices and/or modems), one or more processor(s) 404, and one or more computer readable media 406.

The system 400 may include one or more communication interfaces(s) 402 that enable communication between the system 400 and one or more other local or remote computing device(s) or remote services, such as a user devices or third-party system as illustrated with respect to FIG. 1. For instance, the communication interface(s) 402 can facilitate communication with other central processing systems, a user device, or other third-party systems to receive and provide diagrams in various formats. The communications interfaces(s) 402 may enable Wi-Fi-based communication such as via frequencies defined by the IEEE 802.11 standards, short range wireless frequencies such as Bluetooth, cellular communication (e.g., 2G, 3G, 4G, 4G LTE, 5G, etc.), satellite communication, dedicated short-range communications (DSRC), or any suitable wired or wireless communications protocol that enables the respective computing device to interface with the other computing device(s).

The system 400 may include one or more processors 404 and one or more computer-readable media 406. Each of the processors 404 may itself comprise one or more processors or processing cores. The computer-readable media 406 is illustrated as including memory/storage. The computer-readable media 406 may include volatile media (such as random access memory (RAM)) and/or nonvolatile media (such as read only memory (ROM), Flash memory, optical disks, magnetic disks, and so forth). The computer-readable media 406 may include fixed media (e.g., RAM, ROM, a fixed hard drive, and so on) as well as removable media (e.g., Flash memory, a removable hard drive, an optical disc, and so forth). The computer-readable media 406 may be configured in a variety of other ways as further described below.

Several modules such as instructions, data stores, and so forth may be stored within the computer-readable media 406 and configured to execute on the processors 404. For example, as illustrated, the computer-readable media 406 stores diagram data generation instructions 408, storage instructions 410, authentication instructions 412, diagram generation instructions 414, obfuscation instructions 416, format selection instruction 418, configuration and setting generation instructions 420 as well as other instructions, such as an operating system. The computer-readable media 406 may also be configured to store data, such as diagram data 422, one or more machine learned models 424, organizational rules data 426, authentication data 428, as well as other data.

The diagram data generation instructions 408 may be configured to receive the diagram in an original format and to detect the objects and/or relationships between the objects in order to generate the diagram data 422 which may be used to reconstruct the diagram in another format. As discussed above, the diagram data generation instructions 408 may utilize one or more machine learning models to segment, detect, and/or classify the objects and/or relationships within the diagram.

The storage instructions 410 may be configured to determine a location at which to store the diagram data 422 and/or the diagram in a desired format of the organization. For example, once the diagram data 422 is determined as data or code, the storage instructions 410 may be configured to determine a storage location based on, for instance, creators team, creators job description, creators identity, type of diagram, original format of the diagram, security level applied to the diagram, and the like.

The authentication instructions 412 may be configured to determine, such as based at least in part on authentication data 428 and the organizational rule data 426, if a user or third-party system requesting access to a diagram is allowed to view or otherwise access the requested diagram.

The diagram generation instructions 414 may be configured to receive a request for a diagram in a specific format and to access the diagram data 422 associated with the requested diagram and to generate a corresponding diagram in the requested format from the diagram data 422. In some cases, it should be understood that the diagram generation instructions 414 may generate multiple diagrams in different formats that correspond to the original diagram. In some cases, the diagram generation instructions 414 may utilize one or more machine learning models 424, as discussed above, to generate the diagrams in various formats from the diagram data 422 and/or the original diagram in the original format.

In some examples, the diagram generation instructions 414 be configured to receive a request for conversion of a diagram into code, such as Python code, or other types of object code that may be edited by a user. In these cases, the diagram generation instructions 414 may generate the code or object data in multiple formats or computer programming languages for editing by a user in one or more tools. As discussed above, in some cases, the diagram generation instructions 414 may utilize one or more machine learning models 424 to generate the code or object data.

The obfuscation instructions 416 may be configured to determine if the user or third-party requesting access to the diagram is only authorized to view a portion of the diagram. For example, the obfuscation instructions 416 may determine portions of the diagram that the user is authorized to view based at least in part on the organizational rule data 426 and/or the authentication data 428 provided by the user when requesting the diagram. In some cases, the obfuscation instructions 416 may be configured to limit the diagram generated by the diagram generation instructions 414 to the portions the user is authorized to access. In other cases, the obfuscation instructions 416 may remove or obfuscate the portions of the diagram the user is restricted from accessing.

The format selection instruction 418 may assist a user and/or the system 400 in selecting the format to generate the diagram in. For example, the organizational rule data 426 may place restrictions or limits on the format, tools, or the like that the diagram may be converted to or accessed via. In some case, the format selection instructions 418 may make recommendations for viewing the diagram based at least in part on the diagram data 422 and the like. In some cases, the recommendations may be responsive to the user or third-party attempting to access the diagram data 422 in a format that is not authorized by the organization.

The configuration and setting generation instructions 420 may be configured to receive diagrams data 422 as well as input data (e.g., text-based, visual-based, and/or audio-based) inputs from a user and to generate based on the input data and the diagram data 422 configuration and settings for deployment on hardware (such as network hardware, user equipment, or other devices) as well as via cloud-based software services or hosted applications. In some cases, the configuration and setting generation instructions 420 may utilize the machine learning models 424 (e.g., large language models, generative pre-trained transformers, neural networks, or other models) to generate the configuration and settings.

Although the discussion above sets forth example implementations of the described techniques, other architectures may be used to implement the described functionality and are intended to be within the scope of this disclosure. Furthermore, although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method comprising:
receiving, from a first user device, a first diagram in a first format;
determining, based at least on the first diagram, diagram data;
storing the diagram data;
receiving a request to access the first diagram from a second user device, the request indicating a second format different than the first format;
generating, based at least in part on the diagram data and the second format, a second diagram corresponding to the first diagram, the second diagram in the second format; and
providing the second diagram to the second user device.

2. The method of claim 1, wherein the diagram data includes object data, relationship data, and metadata associated with objects of the first diagram.

3. The method of claim 1, further comprising:
receiving authentication data associated with a user of the second user device with the request to access the first diagram;
determining, based at least in part on the authentication data, a portion of the first diagram the user is authorized to view; and
wherein generation the second diagram includes limiting the second diagram to the portion of the first diagram that the user is authorized to view.

4. The method of claim 1, wherein determining the diagram data further comprises:
inputting the first diagram into one or more first machine learning models trained to segment and classify objects of diagrams and receiving as an output of the one or more first machine learning models object data associated with the first diagram, the one or more first machine learning models trained on diagrams associated with various organizational functions and operable on various different tools; and
inputting the object data into one or more second machine learning models trained to output relationship data associated with the objects of the object data, the one or more second machine learning models trained on object data of various types of objects associated with various types of diagrams operable on various different tools.

5. The method of claim 1, further comprising:
receiving input data from the second user device; and
generating, based at least in part on the input data and the second diagram, a third diagram, code, or object data.

6. The method of claim 1, wherein generating the second diagram corresponding to the first diagram further comprises:
inputting the diagram data and the second format into one or more machine learning models trained to generate diagrams in various formats and receiving as an output of the one or more machine learning models the second diagram in the second format, the one or more machine learning models trained on diagram data associated with various organizational functions and operable on various different tools.

7. A system comprising:
one or more processors;
one or more communication interfaces; and
one or more computer-readable media storing instructions that, when executed by the one or more processors, cause the one or more processors to perform operations comprising:
receiving, from a first user device of a first user, a first diagram in a first format;
determining, based at least on the first diagram, diagram data;
generating, based at least in part on the diagram data, a second diagram in a second format, the second format preferred by an organization associated with the first user; and
storing the second diagram or the diagram data at a location accessible by at least a second user associated with the organization, the second user different than the first user.

8. The system of claim 7, wherein the operations further comprise:
receiving a request to access the first diagram from a second user device associated with a third user, the request indicating a third format different than the first format and the second format;
generating, based at least in part on the diagram data and the third format, a third diagram corresponding to the first diagram, the third diagram in the third format; and
providing the third diagram to the second user device.

9. The system of claim 8, wherein the operations further comprise:
receiving authentication data associated with a user of the second user device with the request to access the first diagram;
determining, based at least in part on the authentication data, a portion of the first diagram the user is authorized to view; and
wherein generation the second diagram includes limiting the second diagram to the portion of the first diagram that the user is authorized to view.

10. The system of claim 7, wherein determining the diagram data further comprises:
inputting the first diagram into one or more first machine learning models trained to segment and classify objects of diagrams and receiving as an output of the one or more first machine learning models object data associated with the first diagram, the one or more first machine learning models trained on diagrams associated with various organizational functions and operable on various different tools; and
inputting the object data into one or more second machine learning models trained to output relationship data associated with the objects of the object data, the one or more second machine learning models trained on object data of various types of object associated with various types of diagrams operable on various different tools.

11. The system of claim 7, wherein generating the second diagram corresponding to the first diagram further comprises:
inputting the diagram data and the second format into one or more machine learning models trained to generate diagrams in various formats and receiving as an output of the one or more machine learning models the second diagram in the second format, the one or more machine learning models trained on diagram data associated with various organizational functions and operable on various different tools.

12. One or more computer-readable media storing instructions that, when executed by one or more processors, cause the one or more processors to perform operations comprising:
receiving a request to access a first diagram from a user device, the first diagram associated with a first format and the request indicating a second format different than the first format;
generating, based at least in part on stored diagram data and the second format, a second diagram corresponding to the first diagram, the second diagram in the second format; and
providing the second diagram to the user device.

13. One or more computer-readable media of claim 12, wherein the operations further comprise:
receiving, from the user device, input data associated with the second diagram;
determining, based at least on the second diagram and the input data, configuration data for deployment on a network; and
applying the configuration data to the network.

14. One or more computer-readable media of claim 13, wherein the input data includes audio data representative of a verbal command of the user of the user device.

15. One or more computer-readable media of claim 12, wherein the operations further comprise:
receiving, from another user device, the first diagram in the first format;
determining, based at least on the first diagram, the diagram data associated with the first diagram; and
storing the diagram data as stored diagram data.

16. One or more computer-readable media of claim 12, wherein the operations further comprise:
receiving authentication data associated with a user of the user device with the request to access the first diagram;
determining, based at least in part on the authentication data, a portion of the first diagram the user is authorized to view; and
wherein generation the second diagram includes limiting the second diagram to the portion of the first diagram that the user is authorized to view.

17. One or more computer-readable media of claim 16, wherein determining the portion of the first diagram the user is authorized to view is based at least in part on organizational rule data associated with data represented by the first diagram.

18. One or more computer-readable media of claim 16, wherein limiting the second diagram to the portion of the first diagram that the user is authorized to view comprises generating the second diagram to include only the portion of the first diagram.

19. One or more computer-readable media of claim 12, wherein the operations further comprise:
determining the second format is not authorized by an organization associated with the first diagram;
generating, based at least in part on the second format, organizational rule data, and the stored diagram data, a third format; and
wherein generating the second diagram corresponding to the first diagram further comprises generating the second diagram in the third format.

20. One or more computer-readable media of claim 12, wherein the operations further comprise:
determining, based at least in part on the second format, organizational rule data, and the stored diagram data, a third format;
generating, based at least in part on the diagram data, a third diagram corresponding to the first diagram in the third format; and
providing the third diagram with the second diagram to the user device.
